(19) United States
(12) Patent Application Publication
(10) Pub. No.: US 2025/0333017 A1
(43) Pub. Date: Oct. 30, 2025

(54) VEHICLE WINDOW GLASS BREAKING SYSTEM AND METHOD OF USE

(71) Applicant: Zhao Yang, Elk Grove Vlg, IL (US)

(72) Inventor: Zhao Yang, Elk Grove Vlg, IL (US)

(21) Appl. No.: 19/049,102

(22) Filed: Feb. 10, 2025

Related U.S. Application Data
(60) Provisional application No. 63/637,910, filed on Apr. 24, 2024.

(51) Int. Cl. B60R 21/0136; A62B 3/00; B60R 21/00

(52) U.S. Cl. CPC B60R 21/0136; A62B 3/005; B60R 2021/0016

(57) ABSTRACT

The present invention is a vehicle window glass (i.e., vehicle door window) breaking system. The system integrates a glass-breaking mechanism with a door handle that offers manual or automatic activation. A concealed button near the handle facilitates manual activation and automatic activation employs sensors autonomously triggered or actuated by water buoyancy or collision impact. The system features a pin (i.e., cylindrical pin) affixed to the edge of the window glass (i.e., vehicle door window), with a driving cable passing through an aperture in the pin. A cable jacket encases the cable, guiding its movement and transmitting pulling force efficiently. When activated, the pin (i.e., cylindrical pin) rotates, generating a shearing force that breaks the glass. The glass installation base anchors the cable jacket, stabilizing the system and distributing stresses.

### CROSS-REFERENCE TO RELATED APPLICATION

The present application claims priority to, and the benefit of, U.S. Provisional Application No. 63/637,910 which was filed on Apr. 24, 2024 and is incorporated herein by reference in its entirety.

### FIELD OF THE INVENTION

The present invention generally relates to vehicle safety systems. More specifically, the invention relates to an integrated vehicle door and window glass (i.e., vehicle door window) breaking system designed to facilitate emergency egress during life-threatening situations. The system comprises a glass-breaking mechanism integrated into the vehicle door handle and includes a pin (i.e., cylindrical pin) affixed to the edge of the window glass (i.e., vehicle door window) and connected to a driving cable housed within a protective cable jacket. The system includes both manual and automatic activation methods for activation. Upon activation, the driving cable rotates the pin (i.e., cylindrical pin), generating shearing force to shatter the window glass (i.e., vehicle door window). Accordingly, the present disclosure makes specific reference thereto. Nonetheless, it is to be appreciated that aspects of the present invention are also equally applicable to other like applications, devices, and methods of manufacture.

### BACKGROUND

By way of background, vehicle emergencies, such as fires, submersion in water, or post-collision (i.e., impact) immobilization, demand rapid and effective solutions to ensure the safety of occupants. Traditional vehicle windows are designed to be robust and durable for safety and security purposes, but this durability can pose a significant challenge in emergencies. In emergencies, vehicle doors are often jammed and for evacuation, passengers often try to break the windows. However, attempts to break vehicle windows from inside without proper tools are often futile, as common items available within the vehicle are not designed to generate the force or impact required to shatter tempered glass. Further, many occupants do not have the strength to break the window glass (i.e., vehicle door window). Current solutions, such as portable glass-breaking tools, are not integrated into the vehicle and rely on occupants remembering their presence and location during a high-stress situation. The reliance on external devices can compromise effectiveness in emergencies. Individuals desire an improved safety system that overcomes the safety gap of the conventional vehicle windows breaking device.

Therefore, there exists a long-felt need in the art for a vehicle safety mechanism that facilitates quick and efficient escape during emergencies. There is a long-felt need for a system that enables vehicle occupants to break window glass (i.e., vehicle door window) without requiring external tools or significant physical strength. Additionally, there is a long-felt need for an integrated solution that can be easily activated during critical situations, such as water submersion or post-collision (i.e., impact) door jamming. Furthermore, there is a long-felt need for a system that operates automatically when autonomously triggered or actuated by sensors detecting emergencies. More specifically, there exists a long-felt need for a glass-breaking mechanism that remains unobtrusive during normal vehicle operation but becomes readily available during emergencies. Finally, there exists a long-felt need in the art for a robust, durable, and reliable safety system that enhances the chances of survival for vehicle occupants in life-threatening situations.

The subject matter disclosed and claimed herein, in one embodiment, comprises an integrated vehicle door and window glass (i.e., vehicle door window) breaking system. The system includes a glass-breaking mechanism which includes a pin (i.e., cylindrical pin) with an aperture, a driving cable, a coupling mechanism, and a cable jacket. The pin (i.e., cylindrical pin) is securely affixed to the edge of the window glass (i.e., vehicle door window), and the cable passes through the pin's aperture, connecting to the coupling mechanism, and the cable jacket connecting a glass installation base. The system includes dual activation modes including a manual activation mechanism via a concealed button near the door handle, and an automatic activation mechanism autonomously triggered or actuated by a buoyancy sensor or a collision (i.e., impact) sensor. When the system is actuated, the coupling mechanism connects the driving cable to the vehicle door handle, the vehicle door handle rotation then drives the driving cable and rotates the pin (i.e., cylindrical pin), generating a shearing force to break the window glass (i.e., vehicle door window) for evacuation of vehicle occupants. In one embodiment, the system is actuated upon opening of the vehicle door handle which initiates driving of the cable and rotation of the pin.

In this manner, the integrated vehicle door and window glass (i.e., vehicle door window) breaking system of the present invention accomplishes all of the foregoing objectives and provides a practical solution for emergency escape scenarios. The system eliminates the need for external tools by incorporating a glass-breaking mechanism directly into the vehicle door, making it readily accessible during emergencies. The manual activation option enables users to engage the system directly (i.e., via a concealed button), while the automatic activation ensures the mechanism operates autonomously in conditions such as water submersion or severe collision (i.e., impacts). The pin (i.e., cylindrical pin) and driving cable mechanism provide efficient transmission of vehicle door handle rotation force to the window glass (i.e., vehicle door window), effectively breaking the window glass (i.e., vehicle door window) without damaging other vehicle components.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle window glass (i.e., vehicle door window) breaking system. The system comprises a pin (i.e., cylindrical pin) affixed to edge of a window glass (i.e., vehicle door window), the pin (i.e., cylindrical pin) includes an opening, and a cable is connected perpendicularly to the pin (i.e., cylindrical pin) and through the opening. A driving cable jacket is fixed to a glass installation base for guiding and stabilizing the cable movement. A manual engagement mechanism, for example a concealed button, is operable by a user for coupling the cable to the door handle, thereafter actuation or rotation of the door handle pulls the cable, wherein pulling the cable rotates the pin (i.e., cylindrical pin), generating a shearing force at the edge of the pin (i.e., cylindrical pin) to break the window glass (i.e., vehicle door window). The manual engagement mechanism is concealed within the inner door panel and is detachable for backup operation of the automatic activation.

In another aspect, a vehicle safety system for breaking window glass (i.e., vehicle door window) in emergencies is disclosed. The system includes a door-opening handle configured to actuate a glass-breaking mechanism, a coupling mechanism is configured to connect the drive cable to the door handle, a cable-driven mechanism comprising a cable, a cable jacket, and a pin (i.e., cylindrical pin) attached to the edge of the window glass (i.e., vehicle door window), the pin (i.e., cylindrical pin) is configured to generate shearing force upon rotation thereof. An automatic activation mechanism of the system comprises a water buoyancy trigger for submersion detection, wherein the automatic activation mechanism links the cable to the door handle via a coupling mechanism, whereupon under emergency conditions the occupant(s) will rotate the door handle to escape the vehicle, the door handle rotation forces the cable to rotate the pin (i.e., cylindrical pin) and break the window glass (i.e., vehicle door window).

In another embodiment, a vehicle door system with an integrated emergency glass-breaking device is disclosed. The device includes a glass-breaking mechanism configured to break a vehicle window upon manual or automatic activation, a pin (i.e., cylindrical pin) is fixed to the edge of the window glass (i.e., vehicle door window), the pin is connected to a cable housed within a driving cable jacket, a manual activation mechanism comprises a hidden button near the door handle, operable to link the cable to the door handle via a coupling mechanism, the rotation of the door handle, whereupon the door handle rotation pulls the cable and rotates the pin (i.e., cylindrical pin), wherein the glass-breaking mechanism is designed to operate unobtrusively during normal vehicle use and effectively during emergencies.

In one embodiment, a method for breaking vehicle window glass (i.e., vehicle door window) in an emergency using a vehicle door and window glass (i.e., vehicle door window) breaking system is described. The method includes the steps of detecting an emergency condition, wherein the emergency condition is selected from the group consisting of vehicle submersion in water and a collision (i.e., impact), activating a sensor embedded in the vehicle door, wherein the sensor is autonomously triggered or actuated by at least one of water buoyancy or collision impact, linking the driving cable to the door handle via a coupling mechanism, wherein the emergency condition the occupants will rotate the door handle to escape the vehicle, the handle rotation transmitting a pulling force through a driving cable housed within a cable jacket to a pin (i.e., cylindrical pin) affixed to an edge of the window glass (i.e., vehicle door window), rotating the pin (i.e., cylindrical pin) upon receiving the pulling force, wherein the pin (i.e., cylindrical pin) includes an aperture through which the driving cable passes, and generating a shearing force at the edge of the window glass (i.e., vehicle door window) via the pin (i.e., cylindrical pin), thereby breaking the window glass (i.e., vehicle door window) and providing an emergency exit for occupants.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagrammatic view of the vehicle door and window glass (i.e., vehicle door window) breaking system of the present invention in accordance with the disclosed architecture;

FIG. 2 illustrates a perspective view showing coupling of the pin (i.e., cylindrical pin) and the driving cable for rotation of the pin (i.e., cylindrical pin) in accordance with the disclosed structure; and

FIG. 3 illustrates a side view of the pin (i.e., cylindrical pin) rotation showing breaking of window glass (i.e., vehicle door window) in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a vehicle safety mechanism that facilitates quick and efficient escape during emergencies. There is a long-felt need for a system that enables vehicle occupants to break window glass (i.e., vehicle door window) without requiring external tools or significant physical strength. Additionally, there is a long-felt need for an integrated solution that can be easily activated during critical situations, such as water submersion or post-collision (i.e., impact) door jamming. Furthermore, there is a long-felt need for a system that operates automatically when autonomously triggered or actuated by sensors detecting emergencies. More specifically, there exists a long-felt need for a glass-breaking mechanism that remains unobtrusive during normal vehicle operation but becomes readily available during emergencies. Finally, there exists a long-felt need in the art for a robust, durable, and reliable safety system that enhances the chances of survival for vehicle occupants in life-threatening situations.

The present invention, in one exemplary embodiment, is a method for breaking vehicle window glass (i.e., vehicle door window) in an emergency using a vehicle door and window glass (i.e., vehicle door window) breaking system. The method includes the steps of detecting an emergency condition, wherein the emergency condition is selected from the group consisting of vehicle submersion in water and a collision (i.e., impact), activating a sensor embedded in the vehicle door, wherein the sensor is autonomously triggered or actuated by at least one of water buoyancy or collision impact, linking the driving cable to the door handle vial a coupling mechanism, wherein under emergency conditions the occupants(s) will rotate the door handle to escape the vehicle, the handle rotation transmits a pulling force through a driving cable housed within a cable jacket to a pin (i.e., cylindrical pin) affixed to an edge of the window glass (i.e., vehicle door window), rotating the pin (i.e., cylindrical pin) upon receiving the pulling force from the vehicle door handle, for example from a vehicle door handle, wherein the pin (i.e., cylindrical pin) includes an aperture through which the driving cable passes, and generating a shearing force at the edge of the window glass (i.e., vehicle door window) via the pin (i.e., cylindrical pin), thereby breaking the window glass (i.e., vehicle door window) and providing an emergency exit for occupants.

Reference will now be made in detail to the present preferred embodiments of the invention, examples of which are illustrated in the accompanying drawings. Wherever possible, the same reference numerals are used in the drawings and the description to refer to the same or like parts.

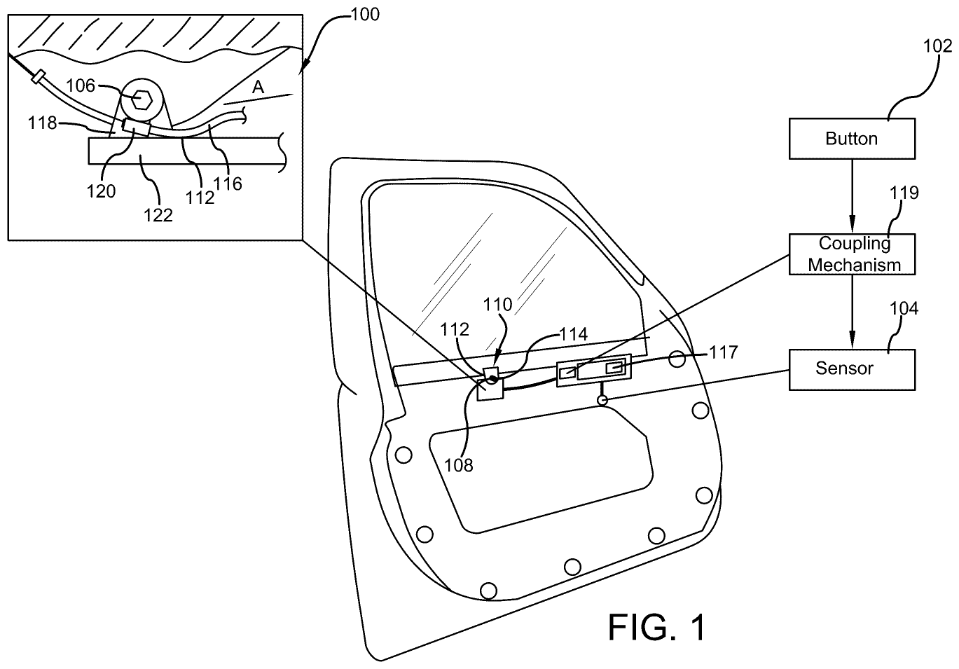

Referring initially to the drawings, FIG. 1 illustrates a diagrammatic view of vehicle door and window glass (i.e., vehicle door window) breaking system of the present invention in accordance with the disclosed architecture. The vehicle door and window glass (i.e., vehicle door window) breaking system 100 of the present invention is designed as a safety system to address emergency situations, such as when a vehicle is submerged in water or when the doors are jammed after a collision (i.e., impact). More specifically, the system 100 is used with a door of a vehicle and includes an actuation button (i.e., actuator) 102 integrated in the vehicle door and preferably, near the handle of the door. The actuation button (i.e., actuator) 102 enables a user to manually activate the system 100 to shatter the window of the door to which the actuation button (i.e., actuator) 102 is integrated. The actuation button (i.e., actuator) 102 is preferably a push button but can be any conventional toggle, soft, or touch button.

A sensor 104 such as electromagnetic actuator embedded collision (i.e., impact) sensor is included in the system 100. The sensor 104 is adapted to be autonomously triggered or actuated by water buoyancy when a vehicle, such as a car, is submerged or when the car is in a collision (i.e., impact) to automatically (i.e., autonomously) activate the system 100 to shatter the window. The core component of the emergency vehicle door and window glass (i.e., vehicle door window) breaking system 100 is a pin (i.e., cylindrical pin) 106 which includes an aperture 108 disposed therein. The pin (i.e., cylindrical pin) 106 has a fixed end 110 which is affixed to an edge 112 of the window glass (i.e., vehicle door window) using a fastening means such as a strong adhesive. The opening or aperture 108 is preferably disposed near the opposite end 114 of the pin (i.e., cylindrical pin) 106.

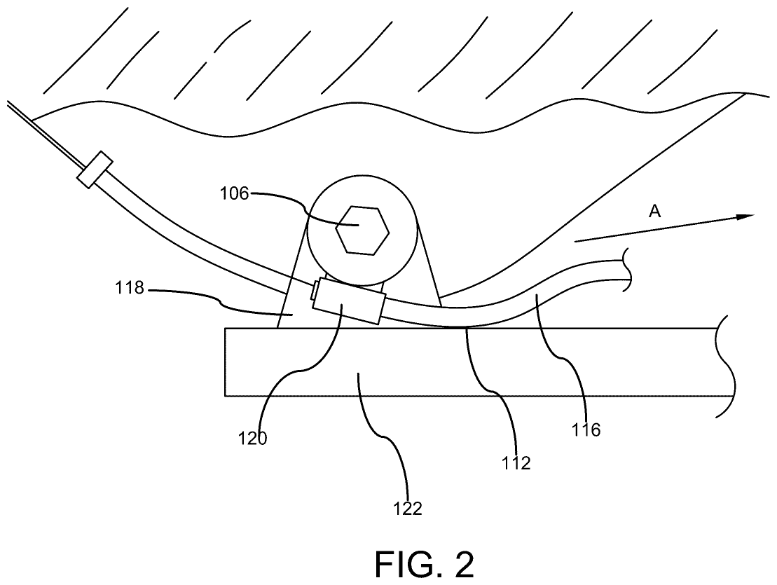

A driving cable 116 passes through the aperture 108 and the cable 116 is configured to connect the pin (i.e., cylindrical pin) 106 to a glass installation base 118. The glass installation base 118 is located at the bottom or side edge of the window glass (i.e., vehicle door window), inside the car door. A cable jacket 120 as shown in FIG. 2 encases the driving cable 116 and protects it from physical damage, such as wear, tear, or corrosion. The jacket 120 provides a controlled pathway for the cable 116 and enables that the force is efficiently transmitted to the pin (i.e., cylindrical pin) 106.

In use, when the driving cable 116 is pulled either manually or autonomously, the free end 114 of the pin (i.e., cylindrical pin) 106 is rotated and the rotation creates a sheering force at the edge of the edge 112 of the window glass (i.e., vehicle door window), effectively breaking the window glass (i.e., vehicle door window). The manual activation mechanism comprises the hidden button 102 near the door handle 117, operable to link the cable 116 to the door handle 117 via a coupling mechanism 119. Once the coupling mechanism 119 is actuated by the button 102, whereupon the door handle 117 rotation pulls the cable 116 and rotates the pin (i.e., cylindrical pin) 106, wherein the glass-breaking mechanism is designed to operate unobtrusively during normal vehicle use and effectively during emergencies.

In one embodiment, once the system 100 is actuated by the button 102 and coupling mechanism 119, operating (i.e., pulling) of the vehicle door handle 117 pulls the driving cable 116 and rotates the pin 106.

FIG. 2 illustrates a perspective view showing coupling of the pin 106 and the driving cable 116 for rotation of the pin 106 of the integrated glass breaking device for vehicle doors in accordance with the disclosed structure. As illustrated, the cable jacket 120 encases at least a portion of the cable 116. The glass installation base 118 provides a stable and secure mount for the window glass (i.e., vehicle door window) 122 within the door frame. The glass installation base 118 anchors the cable jacket 120 and enables the cable 116 to transmit pulling force effectively to the pin (i.e., cylindrical pin) 106 attached to the edge of the glass 122. When the cable 116 is pulled in the direction as indicated by arrow A, the installation base 118 absorbs and distributes mechanical stresses generated by the cable and pin system, thereby breaking the window glass (i.e., vehicle door window) and preventing damage to other components of the door.

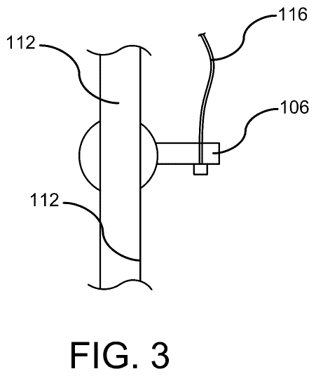

FIG. 3 illustrates a side view of the pin (i.e., cylindrical pin) rotation showing breaking of window glass (i.e., vehicle door window) in accordance with the disclosed structure. As illustrated, when the driving cable 116 is pulled either manually or autonomously, the driving cable 116 causes the pin (i.e., cylindrical pin) 106 to rotate enabling the pin (i.e., cylindrical pin) 106 to squeeze the window glass (i.e., vehicle door window) 122 to shatter the glass and thus providing an egress for an occupant to get out of the vehicle.

It should be noted that the door handle 117 of the vehicle in which the system 100 is installed operates normally to open the vehicle door. The glass-breaking system 100 of the present invention remains inactive, integrated unobtrusively into the door handle and inner panel. In manual activation, a user presses a concealed actuation button (i.e., actuator) 102 near the handle to engage the coupling mechanism 119, whereupon pulling of the handle 117 actuates the integrated glass breaking device for vehicle doors 100. For automatic activation, the buoyancy-autonomously triggered or actuated sensor 104 detects water pressure and activates the system 100. The manual or automatic trigger pulls the driving cable 116 housed within the cable jacket 120. The cable 116 transmits the pulling force to the pin (i.e., cylindrical pin) 106 attached to the edge 112 of the window glass (i.e., vehicle door window) 122. The installation base 118 absorbs and distributes mechanical stresses generated by the cable and pin system. The broken window provides a quick escape route for occupants in the emergency and the damaged window can be replaced during post-incident repair.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “emergency vehicle door and window glass (i.e., vehicle door window) breaking system”, “integrated glass breaking device for vehicle doors,”, “vehicle door and window glass (i.e., vehicle door window) breaking system”, and “system” are interchangeable and refer to the emergency vehicle door and window glass (i.e., vehicle door window) breaking system 100 of the present invention.

Notwithstanding the forgoing, the emergency vehicle door and window glass (i.e., vehicle door window) breaking system 100 of the present invention can be of any suitable size and configuration as is known in the art without affecting the overall concept of the invention, provided that it accomplishes the above stated objectives. One of ordinary skill in the art will appreciate that the emergency vehicle door and window glass (i.e., vehicle door window) breaking system 100 as shown in the FIGS. are for illustrative purposes only, and that many other sizes and shapes of the emergency vehicle door and window glass (i.e., vehicle door window) breaking system 100 are well within the scope of the present disclosure. Although the dimensions of the emergency vehicle door and window glass (i.e., vehicle door window) breaking system 100 are important design parameters for user convenience, the emergency vehicle door and window glass (i.e., vehicle door window) breaking system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle door window glass breaking system comprising:
a vehicle door;
a vehicle door window;
an actuator;
a coupling mechanism;
a sensor;
a cable;
a vehicle door handle; and
a pin;
wherein said pin having an aperture disposed therein;
wherein said pin having a first end affixed to an edge of said vehicle window;
wherein said aperture disposed proximal to an opposing second end of said pin;
wherein said actuator is both selectively manually actuated and autonomously actuated;
wherein said actuator including said coupling mechanism for linking said cable to said vehicle door handle;
wherein said cable passes through said aperture;
wherein said cable connects said pin to a glass base;
wherein said glass base is the edge of said vehicle door window inside said vehicle door; and
further wherein said actuator engaging said vehicle door handle for pulling said cable and for rotating said pin to break said vehicle door window when said vehicle door handle is pulled.

2. The vehicle door window glass breaking system of claim 1, wherein said cable having a cable jacket encasing at least a portion of said cable for providing a controlled pathway for said cable.

3. The vehicle door window glass breaking system of claim 2, wherein said actuator including a push button.

4. The vehicle door window glass breaking system of claim 1, wherein said sensor autonomously actuates said actuator when said sensor detects water buoyancy when the vehicle is submerged in water.

5. The vehicle door window glass breaking system of claim 1, wherein said sensor autonomously actuates said actuator when said sensor detects impact when the vehicle is in a collision.

6. The vehicle door window glass breaking system of claim 4, wherein said sensor is an electromagnetic actuator embedded sensor.

7. The vehicle door window glass breaking system of claim 5, wherein said sensor is an electromagnetic actuator embedded sensor.

8. A vehicle door window glass breaking system comprising:
a vehicle door;
a vehicle door window;
an actuator;
a sensor;
a cable; and
a pin;
wherein said pin having an aperture disposed therein;
wherein said pin having a first end affixed to an edge of said vehicle window;
wherein said aperture disposed proximal to an opposing second end of said pin;
wherein said actuator is autonomously actuated;
wherein said cable passes through said aperture;
wherein said cable connects said pin to a glass base;
wherein said glass base is the edge of said vehicle door window inside said vehicle door; and
further wherein said actuator pulls said cable for rotating said pin to break said vehicle door window.

9. The vehicle door window glass breaking system of claim 8, wherein said cable having a cable jacket encasing at least a portion of said cable for providing a controlled pathway for said cable.

10. The vehicle door window glass breaking system of claim 8, wherein said sensor autonomously actuates said actuator when said sensor detects water buoyancy when the vehicle is submerged in water.

11. The vehicle door window glass breaking system of claim 8, wherein said sensor autonomously actuates said actuator when said sensor detects impact when the vehicle is in a collision.

12. The vehicle door window glass breaking system of claim 10, wherein said sensor is an electromagnetic actuator embedded sensor.

13. The vehicle door window glass breaking system of claim 11, wherein said sensor is an electromagnetic actuator embedded sensor.

14. A vehicle door window glass breaking system comprising:
a vehicle door;
a vehicle door window;
an actuator;
a coupling mechanism;
a sensor;
a cable;
a vehicle door handle; and
a pin;
wherein said pin having an aperture disposed therein;
wherein said pin having a first end affixed to an edge of said vehicle window;
wherein said aperture disposed proximal to an opposing second end of said pin;
wherein said cable passes through said aperture;
wherein said cable connects said pin to a glass base;
wherein said glass base is the edge of said vehicle door window inside said vehicle door;
wherein said actuator including said coupling mechanism for linking said cable to said vehicle door handle; and
further wherein said actuator engages said vehicle door handle for pulling said cable and rotating said pin to break said vehicle door window when said vehicle door handle is pulled.

15. The vehicle door window glass breaking system of claim 14, wherein said actuator is both selectively manually actuated and autonomously actuated.

16. The vehicle door window glass breaking system of claim 15, wherein said actuator including a push button.

17. The vehicle door window glass breaking system of claim 15, wherein said sensor autonomously actuates said actuator when said sensor detects water buoyancy when the vehicle is submerged in water.

18. The vehicle door window glass breaking system of claim 15, wherein said sensor autonomously actuates said actuator when said sensor detects impact when the vehicle is in a collision.

19. The vehicle door window glass breaking system of claim 17, wherein said sensor is an electromagnetic actuator embedded sensor.

20. The vehicle door window glass breaking system of claim 18, wherein said sensor is an electromagnetic actuator embedded sensor.
